(19) United States
(12) Patent Application Publication
(10) Pub. No.: US 2018/0154624 A1
(43) Pub. Date: Jun. 7, 2018

(54) POSITIVE SEALANT PLACEMENT AND PROCESSING INDICATING ADHESIVE

(71) Applicant: TYCO ELECTRONICS CORPORATION, Berwyn, PA (US)

(72) Inventor: Inho MYONG, Newark, CA (US)

(21) Appl. No.: 15/800,254

(22) Filed: Nov. 1, 2017

Related U.S. Application Data
(60) Provisional application No. 62/429,342, filed on Dec. 2, 2016.

(51) Int. Cl. B32B 37/12; B29C 61/06; B29C 65/68; B29C 65/48

(52) U.S. Cl. CPC B32B 37/1207; B29C 61/0616; F16L 47/22; B29C 65/4815; B29C 65/68

(57) ABSTRACT

A process of heat recovering tubing includes forming a multilayer tubing assembly, heating the multilayer tubing assembly to a shrink temperature to form a heat-recovered tubing assembly, and visually inspecting the heat-recovered tubing assembly for a presence of at least one colorant. A multilayer tubing assembly and an adhesive assembly are also disclosed. The multilayer tubing assembly includes an outer tubing of a heat-recoverable material, an inner tubing of a heat-meltable material, a substrate encased by the inner tubing, at least one protrusion encased by the inner tubing, and an adhesive strip including an adhesive composition and the colorant. The outer tubing encases the inner tubing. The adhesive strip is located between the substrate and the protrusion.

### CROSS-REFERENCE TO RELATED APPLICATION

This patent application claims the benefit of U.S. Provisional Patent Application Ser. No. 62/429,342, filed on Dec. 2, 2016 and entitled “POSITIVE SEALANT PLACEMENT AND PROCESSING INDICATING ADHESIVE”, the disclosure of which is incorporated by reference as if fully rewritten herein.

### FIELD OF THE INVENTION

The present invention is directed to adhesives. In particular, the present invention is directed to indicating adhesives for heat-recoverable tubing assemblies.

### BACKGROUND OF THE INVENTION

Heat-recoverable, heat-shrinkable tubing has many different applications as a protective covering for components, such as electronic components, electrical components, and fiber optics components. Upon the application of heat during a heat recovery process, the tubing shrinks to contact the component or components protected by the tubing. When made with suitable material parameters, especially suitable electrical conductivity and permittivity, heat-recoverable, heat-shrinkable tubing is also capable of grading an electric field of the component.

The use of multiple layers of tubing permits different compositions to be used in the different layers to provide multiple functions, such as stress control, insulation, and durability against environmental stresses.

When multiple components are encased by the tubing, the geometry of the components may cause an open channel to be formed along the components during the heat recovery process. If the open channel remains after the heat recovery process, the open channel may permit fluid ingress, which may be damaging to the components of the assembly that may require protection from fluid or moisture.

### SUMMARY OF THE INVENTION

An embodiment is directed to a multilayer tubing assembly including an outer tubing of a heat-recoverable material, an inner tubing of a heat-meltable material, a substrate encased by the inner tubing, at least one protrusion encased by the inner tubing, and an adhesive strip including an adhesive composition and at least one colorant. The outer tubing encases the inner tubing. The adhesive strip is located between the substrate and the protrusion.

An embodiment is directed to an adhesive assembly including at least one adhesive strip including an adhesive composition and at least one colorant. The adhesive composition includes an adhesive or a thermally-reactive material. The colorant is visible under visible light or ultraviolet light after going through a heat-recovery process. The colorant is embedded in a portion of the adhesive composition or applied as part of a colored pressure-sensitive tape.

An embodiment is directed to a process of heat recovering tubing including forming a multilayer tubing assembly, heating the multilayer tubing assembly to a shrink temperature to form a heat-recovered tubing assembly, and visually inspecting the heat-recovered tubing assembly for a presence of at least one colorant. The multilayer tubing assembly includes an outer tubing of a heat-recoverable material, an inner tubing of a heat-meltable material, a substrate encased by the inner tubing, at least one protrusion encased by the inner tubing, and an adhesive strip including an adhesive composition and the colorant. The outer tubing encases the inner tubing. The adhesive strip is located between the substrate and the protrusion.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic cross sectional view of a multilayer tubing assembly with an adhesive strip in an embodiment of the present disclosure.

FIG. 2 is a schematic cross sectional view of a multilayer tubing assembly with an adhesive strip attached to the inner wall of the inner tubing in an embodiment of the present disclosure.

FIG. 3 is an adhesive assembly including a backing and discrete adhesive strips with a colorant on a portion of the adhesive strips in an embodiment of the present disclosure.

FIG. 4 is an adhesive assembly with a backing and a continuous adhesive strip with a colorant on a portion of the adhesive strip in an embodiment of the present disclosure.

FIG. 5 is an adhesive assembly with a backing and adhesive strips being perforated or precut in the same direction in an embodiment of the present disclosure.

FIG. 6 is an adhesive assembly with a backing and adhesive strips being perforated or precut in alternating directions in an embodiment of the present disclosure.

FIG. 7 is a schematic perspective view of the multilayer tubing assembly of FIG. 1.

### DETAILED DESCRIPTION OF THE INVENTION

The description of illustrative embodiments, according to principles of the present invention, is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms, such as “lower”, “upper”, “horizontal”, “vertical”, “above”, “below”, “up”, “down”, “top”, and “bottom” as well as derivative thereof (e.g., “horizontally”, “downwardly”, “upwardly”, etc.), should be construed to refer to the orientation as then described or as shown in the drawing under discussion. These relative terms are for convenience of description only and do not require that the apparatus be constructed or operated in a particular orientation unless explicitly indicated as such. Terms, such as “attached”, “affixed”, “connected”, “coupled”, “interconnected”, and similar, refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

An adhesive composition provides additional sealing between certain components within a heat-recovered multilayer tubing. A colorant associated with the adhesive composition in an adhesive strip provides a positive visual indication of the presence of the adhesive composition after the heat recovery process. Without the colorant, it is not possible to know if the adhesive composition was placed or not, once the adhesive composition melts and integrates with the adhesive layer of tubing. In certain instances, it is important to know after the recovery process is complete that this adhesive composition was included and is in place and not forgotten or omitted purposely or inadvertently. In some embodiments, the colorant also provides a positive visual identification that adequate heating was provided during the heat recovery process.

Referring to FIG. 1, a multilayer tubing assembly 10 includes an outer tubing 12, an inner tubing 14, a substrate 16, at least one protrusion 18, 20, shown as a first protrusion 18 and a second protrusion 20 in FIG. 1, and an adhesive strip 22. The outer tubing 12 and the inner tubing 14 are substantially tubular in shape, with the inner tubing 14 being encased by or located inside the outer tubing 12. The substrate 16, the first protrusion 18, the second protrusion 20, and the adhesive strip 22 are arranged within the inner tubing 14 such that the adhesive strip 22 sits between the substrate 16 and the protrusions 18, 20, as shown in FIG. 1. In some embodiments, localized heat, such as from a hot knife, is used to heat a portion of the adhesive strip 22, and that heated portion is adhered to the substrate 16, the first protrusion 18, or the second protrusion 20 during assembly of the multilayer tubing assembly 10 to insure that the adhesive strip 22 stays at the appropriate location prior to the heat recovery process.

The protrusions 18, 20 may be separate components from the substrate 16 or may be attached to or otherwise physically associated with the substrate 16. In some embodiments, the adhesive strip 22 is not adhered to the inner wall 24 of the inner tubing 14. In some embodiments, the adhesive strip 22 is not in contact with the inner wall 24 of the inner tubing 14 at the start of heating.

Upon heating of the multilayer tubing assembly 10 during a heat recovery process to shrink the outer tubing 12 toward the substrate 16, the first protrusion 18, and the second protrusion 20, and to melt the inner tubing 14, the adhesive strip 22 also melts and fills and seals a void 26 defined by the substrate 16 and the at least one protrusion 18, 20. In some embodiments, the void 26 is defined by the substrate 16 and a plurality of protrusions 18, 20. Without the adhesive strip 22, the void 26 may remain open as the outer tubing 12 shrinks and the inner tubing 14 melts during the heat recovery process to form an open channel that may serve as a leak path for fluid ingress after the heat recovery process, which is detrimental to the multilayer tubing assembly 10. Although three components, namely the substrate 16, the first protrusion 18, and the second protrusion 20, each having a cylindrical shape, are shown in FIG. 1, use of the adhesive strip 22 is not limited to such an arrangement and/or such a geometry. The adhesive strip 22 may be used with any number of components greater than one that may have any geometries that together form such a void 26 or such an open channel.

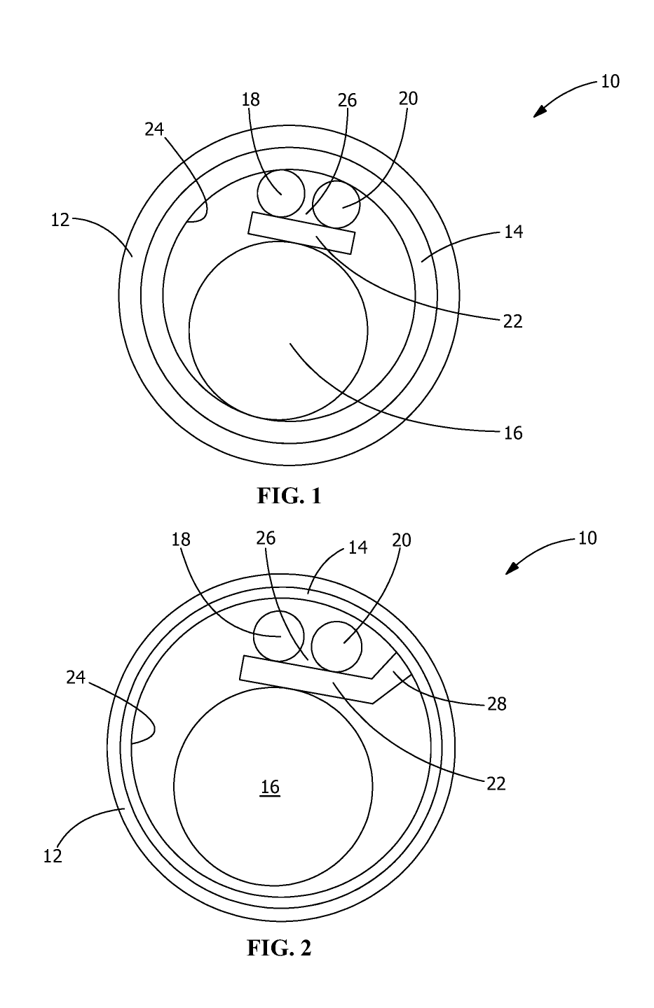

Referring to FIG. 2, the multilayer tubing assembly 10 includes an outer tubing 12, an inner tubing 14, a substrate 16, a first protrusion 18, a second protrusion 20, and an adhesive strip 22. In this case, the adhesive strip 22 sits between the substrate 16 and the protrusions 18, 20, but the adhesive strip 22 also includes a tab 28 that is attached to the inner wall 24 of the inner tubing 14 prior to heating. In some embodiments, the adhesive strip 22 is attached to the inner wall 24 of the inner tubing 14 by an adhesive. In some embodiments, localized heat, such as from a hot knife, is used to heat the tab 28, and the tab 28 is contacted to the inner wall 24 of the inner tubing 14 to adhere the adhesive strip 22 to the inner tubing 14.

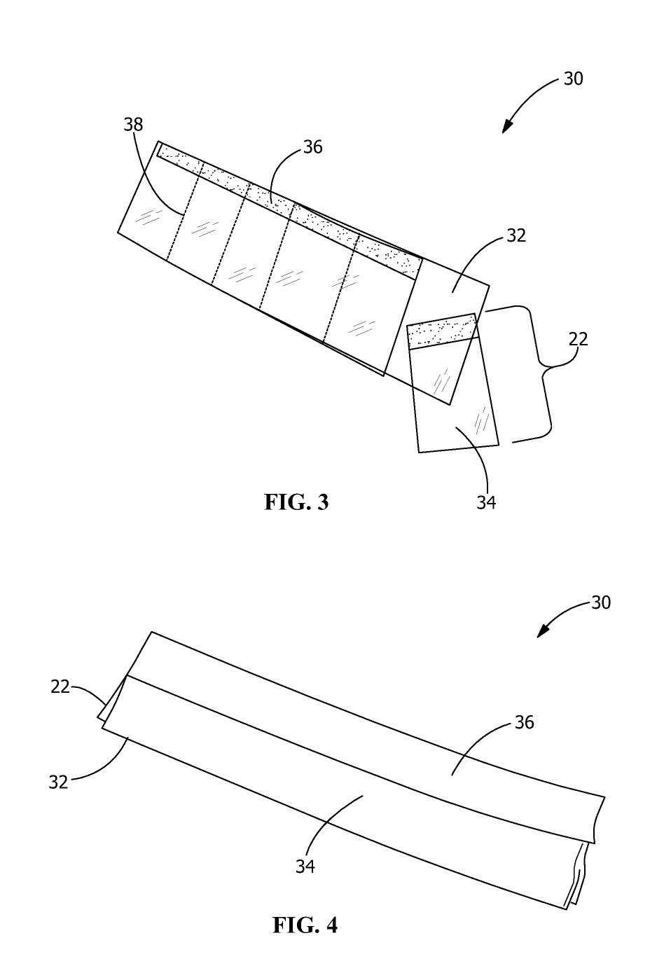

Referring to FIG. 3, an adhesive assembly 30 includes a backing 32 and at least one discrete adhesive strip 22 on the backing 32. A series of discrete adhesive strips 22 are shown in FIG. 3. The discrete adhesive strips 22 are defined by cuts or perforations 38 extending across the full length of the adhesive strips 22. The cuts or perforations 38 optionally extend through the backing 32 as well. The backing 32 has a surface material contacting the adhesive strip 22 that is easily separable from the adhesive strip 22. Each adhesive strip 22 includes an adhesive composition 34 and a colorant 36 that is on at least a portion at one end of the adhesive strip 22. In some embodiments, a wider adhesive strip 22, such as the one shown in FIG. 2, may be used when more than three components are in the multilayer tubing assembly 10 or when more than one void 26 may be formed by the components so that all of the voids 26 are filled by the adhesive composition 34.

The colorant 36 may be on, in, or mixed with the adhesive composition 34. In some embodiments, the colorant 36 is impregnated in the adhesive strip 22. Although the adhesive strips 22 are shown as having a substantially rectangular shape, an adhesive strip 22 may have any appropriate shape, including, but not limited to, circular, oval, triangular, rectangular, or square. Although the colorant 36 is shown as being present in a rectangular portion of the adhesive strip 22, the portion having the colorant 36 may have any appropriate shape and may cover any appropriate portion up to all of the area of the adhesive strip 22. The colorant 36 may be present in about 10% to about 60% of the area of the adhesive strip 22, alternatively about 20% to about 50%, alternatively about 25% to about 40%, alternatively about 20%, alternatively about 25%, alternatively about 40%, alternatively about 50%, or any amount, range, or sub-range therebetween.

The colorant 36 may be any composition or material that provides a visible indication that the adhesive strip 22 has been included in the multilayer tubing assembly 10. The colorant 36 may be a pigment that is detectable under visible light, a pigment that is detectable under ultraviolet light, a thermochromic material that changes color upon exposure to heat, an opaque material, a material having an opacity visually different from the adhesive material, or any combination thereof. The colorant is preferably visible under visible light or ultraviolet light after going through a heat-recovery process. The colorant may be embedded in a portion of the adhesive composition or applied as part of a colored pressure-sensitive tape.

In some embodiments, the thermochromic material is selected to change color or to become a predetermined color at or near the shrink temperature at which the heat recovery process preferably occurs. In some embodiments, the thermochromic material is selected such that a color change to the thermochromic material indicates a successful heat recovery process. The color change of the thermochromic material is preferably irreversible such that the color remains as proof of application of an appropriate amount of heat. In some embodiments, the shrink temperature is in the range of about 80° C. to about 230° C. (about 176° F. to about 446° F.), alternatively about 80° C. to about 150° C. (about 176° F. to about 302° F.), about 150° C. to about 230° C. (about 302° F. to about 446° F.), about 80° C. to about 100° C. (about 176° F. to about 212° F.), about 100° C. to about 150° C. (about 212° F. to about 302° F.), about 150° C. to about 200° C. (about 302° F. to about 392° F.), about 200° C. to about 230° C. (about 392° F. to about 446° F.), or any value, range, or sub-range therebetween.

In embodiments where the adhesive composition 34 is transparent, the colorant 36 may be any color or opacity that contrasts with at least one of the substrate 16, the first protrusion 18, and the second protrusion 20 of the multilayer tubing assembly 10, such that the presence of the colorant 36 in the multilayer tubing assembly 10 is determinable. In some embodiments, the colorant 36 is only detectable prior to the heat recovery process. In some embodiments, the colorant 36 is only detectable after the heat recovery process. In some embodiments, the colorant 36 is detectable both before and after the heat recovery process. In some embodiments, the colorant 36 has a different appearance before and after the heat recovery process.

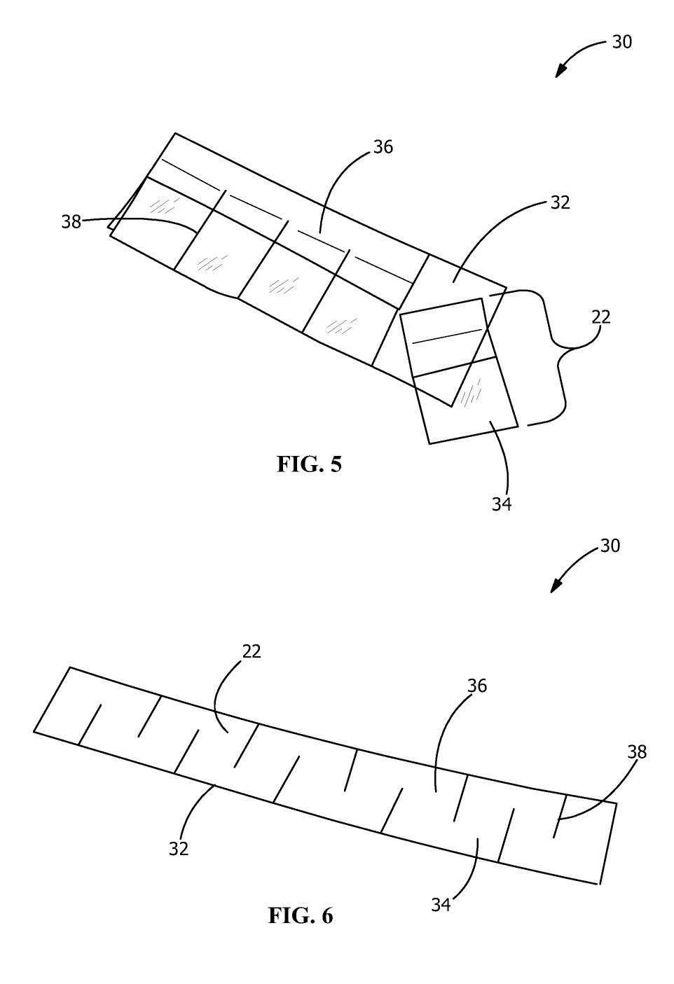

Referring to FIG. 4, the adhesive assembly 30 includes a backing 32 and a continuous piece of adhesive strip 22 on the backing 32. The adhesive assembly 30 includes an adhesive composition 34 and a colorant 36 that is on at least a portion of the adhesive strip 22. A series of discrete adhesive strips 22 may be obtained by cutting or otherwise separating the adhesive strip 22 into smaller strips. The separated adhesive strips 22 may have different widths to provide different amounts of adhesive composition 34 for different applications or the separated adhesive strips 22 may all have the same width to provide a predetermined amount of adhesive composition 34 for similar applications.

The addition of an insufficient amount of adhesive composition 34 results in an unsealed void 26, whereas the addition of an excessive amount of adhesive composition 34 results in overflow, which may interfere with the proper assembly or operation of the functioning substrate 16. Therefore, it is important to apply a controlled amount of adhesive composition 34. In some embodiments, the adhesive strips 22 are pre-sized by the cuts or perforations 38 to provide the controlled amount necessary to perform a specific operation.

Referring to FIG. 5, the adhesive assembly 30 includes a backing 32 and at least one discrete adhesive strip 22 on the backing 32. A series of discrete adhesive strips 22 are shown in FIG. 5. The discrete adhesive strips 22 are defined by cuts or perforations 38 extending from one end along a portion of the adhesive strip 22. The cuts or perforations 38 optionally extend through the backing 32 as well. The backing 32 has a surface material contacting the adhesive strip 22 that is easily separable from the adhesive strip 22. Each adhesive strip 22 includes an adhesive composition 34 and a colorant 36 that is on at least a portion at one end of the adhesive strip 22.

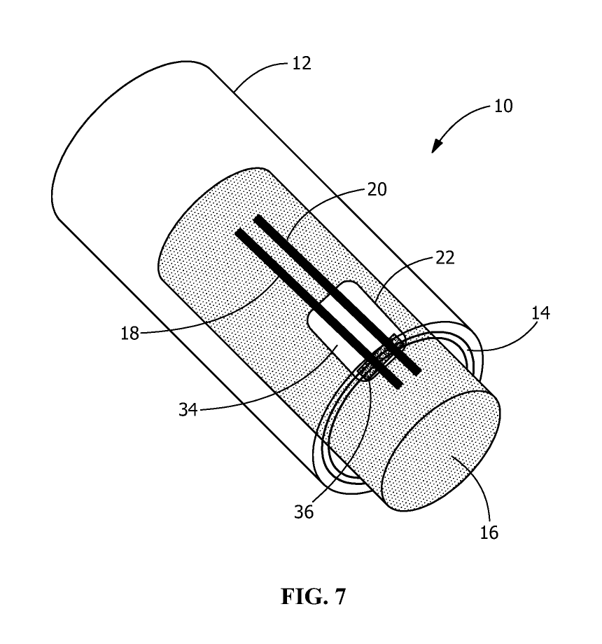

Referring to FIG. 6, the adhesive assembly 30 includes a backing 32 and at least one discrete adhesive strip 22 on the backing 32. A series of discrete adhesive strips 22 are shown in FIG. 6. The discrete adhesive strips 22 are defined by cuts or perforations 38 extending along a portion of the adhesive strip 22 alternating between one end and the other. The cuts or perforations 38 optionally extend through the backing 32 as well. The backing 32 has a surface material contacting the adhesive strip 22 that is easily separable from the adhesive strip 22. Each adhesive strip 22 includes an adhesive composition 34 and a colorant 36 that is on at least a portion of the adhesive strip 22 at one end of the adhesive strip 22. The colorant 36 is not visible prior to the heat recovery process as shown in FIG. 6.

FIG. 7 shows the multilayer tubing assembly 10 of FIG. 1 at a preferred angle for viewing the colorant 36 after the heat recovery process. FIG. 7 also shows a preferred location and orientation of the adhesive strip 22 prior to the heat recovery process. The edge of the adhesive strip 22 having the colorant 36 is located at or near the edge of the outer tubing 12 with the adhesive composition 34 of the adhesive strip 22 extending between the substrate 16 and the first protrusion 18 and second protrusion 20 into the tubing and away from the edge. In some embodiments, an adhesive strip 22 is placed between the substrate 16 and the first protrusion 18 and second protrusion 20 at each end of the outer tubing 12. In some embodiments, additional adhesive strips 22 are placed along the length, and in some embodiments all along the length, of the first protrusion 18 and the second protrusion 20. In some embodiments, the additional adhesive strips 22 do not include a colorant 36, as the colorant may not be visible through the outer tubing 12.

In some embodiments, more adhesive composition 34 or a thicker layer of adhesive composition 34 than what is provided by the predetermined thickness or the predetermined amount of the adhesive strips 22 may be advantageous, depending on the materials and dimensions of the substrate 16 and/or the protrusions 16, 18 in the multilayer tubing assembly 10. In such instances, an adhesive strip 22 may be modified or more than one adhesive strip 22 may be used. In some embodiments, the adhesive strip 22 is folded over on itself to increase the thickness without increasing the amount of adhesive composition 34. In some embodiments, the adhesive strip 22 is slit into two pieces that are stacked on top of each other to increase the thickness of the adhesive composition 34. In some embodiments, the slit or the fold is in a lengthwise direction with the portion having the colorant 36 being stacked on top of itself. In some embodiments, two or more adhesive strips 22 or portions of two or more adhesive strips 22 are stacked on top of each other to form two or more layers, thereby increasing the thickness, and in some cases the amount, of the adhesive composition 34.

The material of the outer tubing 12 may be any heat-recoverable material capable of shrinking to conform to the substrate 16, the first protrusion 18, and the second protrusion 20 during the heat recovery process at a temperature at which the material of the adhesive composition 34 and of the inner tubing 14 melts and/or flows. In some embodiments, the material of the outer tubing 12 includes a partially crystalline thermoplastic material or an elastomeric material. In some embodiments, the material of the outer tubing 12 includes a polyolefin, a polyolefin terephthalate, a fluoropolymer, a fluoroelastomer, a chemically-crosslinkable polymer, an irradiation-crosslinkable polymer, or any combination thereof.

The material of the inner tubing 14 may be any material that melts and/or flows during the heat recovery process to fill space between the outer tubing 12 and the substrate 16, the first protrusion 18, and the second protrusion 20 and to adhere to the outer tubing 12, the substrate 16, the first protrusion 18, and the second protrusion 20.

In some embodiments, the material of the outer tubing 12 and the material of the inner tubing 14 are selected to permit visual inspection and detection of the presence of the colorant 36 through the outer tubing 12. In some embodiments, the visual inspection and detection occurs by looking down the end of the multilayer tubing assembly 10, such as from the viewing position shown in FIG. 1 and FIG. 2.

The material of the adhesive composition 34 may be any material that melts and/or flows during the heat recovery process to fill space between the substrate 16 and the at least one protrusion 18, 20 and to adhere to the substrate 16, the first protrusion 18, and the second protrusion 20. In some embodiments, the material of the adhesive composition 34 is the same or similar to the material of the inner tubing 14. In other embodiments, the material of the adhesive composition 34 is different from the material of the inner tubing 14. The adhesive composition 34 preferably includes an adhesive or a thermally-reactive material.

In some embodiments, the inner tubing 14 and/or the adhesive composition 34 is a hot-melt thermoplastic adhesive that is preferably both tough and flexible and is preferably suitable for bonding materials, such as, for example, polymers, such as, for example, polyolefins, polyamides, vinyls, neoprenes, and/or metals, such as, for example, steel and aluminum. In some embodiments, the material of the inner tubing 14 and the material of the adhesive composition 34 are selected such that when molten, the inner tubing 14 integrates with the adhesive composition 34. In some embodiments, the adhesive composition 34 is selected to have a melt flow property such that when molten, the adhesive composition 34 fills a void between the substrate 16 and the at least one protrusion 18, 20. In some embodiments, the adhesive composition 34 is a hot-melt polyamide adhesive with an operating temperature in the range of about −20° C. to about 60° C. (about −4° F. to about 140° F.).

The substrate 16 and the protrusions 18, 20 may be any components or portions of components that may be encased in heat-shrinkable tubing, including, but not limited to, electronic components, electrical components, fiber optics components, electrical wires, or optical wires. Although the substrate 16 and the protrusions 18, 20 generally extend in the direction of the axis of the outer tubing 12 as shown in FIG. 7, the substrate 16 and the protrusions 18, 20 individually and separately may extend along any portion of the length of the outer tubing 12, up to and including the entire length or substantially the entire length of the outer tubing 12. In some embodiments, the protrusions 18, 20 may also or alternatively extend circumferentially around at least a portion of the substrate 16.

In general, a process includes forming a multilayer tubing assembly, heating the multilayer tubing assembly to a shrink temperature to form a heat-recovered tubing assembly, and visually inspecting the heat-recovered tubing assembly for the presence of at least one colorant. A multilayer tubing assembly and an adhesive assembly are also disclosed. In general, an apparatus includes at least one adhesive strip including an adhesive composition and at least one colorant. The presently-disclosed embodiments are therefore to be considered in all respects as illustrative and not restrictive, the scope of the invention being defined by the appended claims and not limited to the foregoing description or embodiments.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention.

1. A multilayer tubing assembly comprising:
an outer tubing of a heat-recoverable material;
an inner tubing of a heat-meltable material, the outer tubing encasing the inner tubing;
a substrate encased by the inner tubing;
at least one protrusion encased by the inner tubing; and
an adhesive strip comprising an adhesive composition and at least one colorant, the adhesive strip being located between the substrate and the at least one protrusion.

2. The multilayer tubing assembly of claim 1, wherein the colorant is in a visible tape laminated to the adhesive composition along an edge of the adhesive strip.

3. The multilayer tubing assembly of claim 1, wherein the colorant comprises a thermochromic material, wherein the thermochromic material becomes a predetermined color at a shrink temperature to indicate the shrink temperature was reached and to indicate the presence of the adhesive strip.

4. The multilayer tubing assembly of claim 1, wherein the adhesive composition is impregnated with the colorant, and the colorant is a visible color indicator contrasting with a color of the substrate.

5. The multilayer tubing assembly of claim 1, wherein the adhesive composition is impregnated with the colorant, and the colorant is a pigment visible under ultraviolet lighting.

6. The multilayer tubing assembly of claim 1, wherein the adhesive strip is attached to an inner surface of the inner tubing.

7. The multilayer tubing assembly of claim 1, wherein the adhesive strip is not in contact with the inner tubing.

8. The multilayer tubing assembly of claim 1, wherein the adhesive composition is selected to have a melt flow property such that when molten, the adhesive composition fills a void between the substrate and the at least one protrusion.

9. The multilayer tubing assembly of claim 1, wherein the adhesive composition is selected to have compatible properties such that when molten, the adhesive composition integrates with an adhesive layer of the outer tubing.

10. The multilayer tubing assembly of claim 1, wherein the adhesive strip has a shape selected to conform to the at least one protrusion.

11. An adhesive assembly comprising:
at least one adhesive strip comprising an adhesive composition and at least one colorant;
wherein the adhesive composition comprises an adhesive or a thermally-reactive material;
wherein the at least one colorant is visible under visible light or ultraviolet light after going through a heat-recovery process; and
wherein the at least one colorant is embedded in a portion of the adhesive composition or applied as part of a colored pressure-sensitive tape.

12. The adhesive assembly of claim 11 further comprising a backing contacting a surface of the adhesive strip.

13. The adhesive assembly of claim 11, wherein the at least one adhesive strip comprises a plurality of adhesive strips in a row separated by discontinuities selected from the group consisting of discrete cuts, partial cuts in a single direction, partial cuts in alternating directions, perforations, and a combination thereof, the plurality of adhesive strips each having a predetermined volume of adhesive composition to provide a predetermined amount of adhesive to seal a void between a substrate and at least one protrusion encased in a multilayer tubing assembly further comprising an outer tubing of a heat-recoverable material and an inner tubing of a heat-meltable material, the outer tubing encasing the inner tubing.

14. A process of heat recovering tubing comprising:
forming a multilayer tubing assembly comprising:
an outer tubing of a heat-recoverable material;
an inner tubing of a heat-meltable material, the outer tubing encasing the inner tubing;
a substrate encased by the inner tubing;
at least one protrusion encased by the inner tubing; and
an adhesive strip comprising an adhesive composition and at least one colorant, the adhesive strip being located between the substrate and the at least one protrusion;
heating the multilayer tubing assembly to a shrink temperature to form a heat-recovered tubing assembly; and
visually inspecting the heat-recovered tubing assembly for a presence of the colorant.

15. The process of claim 14, wherein the step of visually inspecting comprises directing ultraviolet light toward the heat-recovered tubing assembly, wherein the colorant is detectable under the ultraviolet light.

16. The process of claim 14, wherein the step of forming comprises attaching a tab of the adhesive strip to an inner surface of the inner tubing.

17. The process of claim 14 wherein the step of forming comprises attaching the adhesive strip to the substrate.

18. The process of claim 14, wherein the step of visually inspecting comprises determining a color of the colorant in the heat-recovered tubing assembly.

19. The process of claim 14, wherein the step of forming further comprises locating a stack of two or more layers of the adhesive strip between the substrate and the at least one protrusion.
